(19) United States
(12) Patent Application Publication
(10) Pub. No.: US 2004/0152418 A1
(43) Pub. Date: Aug. 5, 2004

(54) Unified digital front end for IEEE 802.11g WLAN system

(75) Inventors: Amit Sinha, Marlborough, MA (US); Manish Bhardwaj, Cambridge, MA (US); Kanu Chadha, Stafford, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Engim, Inc., Acton, MA (US)

(21) Appl. No.: 10/703,192

(22) Filed: Nov. 6, 2003

Related U.S. Application Data
(60) Provisional application No. 60/424,374, filed on Nov. 6, 2002.

(51) Int. Cl. H04B 1/02

(52) U.S. Cl. 455/42; 455/102

(57) ABSTRACT

A unified digital front end filtering circuit is described for IEEE 802.11g protocol compliant systems. The front end uses polyphase rate conversion filters cascaded with channel extraction and pulse shaping filters to accommodate the different sampling rate requirements for orthogonal frequency division multiplexing (OFDM) and direct sequence spread spectrum (DSSS) modulation, which have to be supported simultaneously, without using separate analog front ends.

### RELATED APPLICATION

This application claims the benefit of U.S. Provisional Application No. 60/424,374 filed Nov. 6, 2002. The entire teachings of the above applications are incorporated herein by reference.

### BACKGROUND OF THE INVENTION

Wireless local area networks (LANs) are proliferating with the standardization of the Institute of Electrical and Electronics Engineers (IEEE) 802.11 family of protocols. As standards evolve, newer and better modulation schemes are characterized by different sampling rates and potentially different front ends. For example, the IEEE 802.11b specification uses an 11 megasamples-per-second (Msps) chip rate for its basic direct-sequence-spread-spectrum (DSSS) modulation and for its higher rate complementary-code-keying (CCK) based modulation scheme, while the orthogonal-frequency-division-multiplexing (OFDM) based 802.11a protocol uses a 20 Msps rate. Traditionally, OFDM based 802.11a systems have worked in the 5 gigahertz (GHz) frequency band, while CCK/DSSS based 802.11b systems have occupied the 2.4 GHz Industrial, Scientific, and Medical (ISM) frequency band. Having different standards directed to different frequency bands has long justified having separate radio frequency (RF) and digital front ends. With the recent standardization of IEEE 802.11g, however, which supports both the CCK/DSSS and OFDM modulation standards in the 2.4 GHz band, multi-protocol wireless local area network (WLAN) systems have started appearing in the market.

Thus, the 802.11g protocol can be thought of as a union of the OFDM and CCK/DSSS modulation schemes in the 2.4 GHz band. One of the requirements of the protocol is the ability to automatically detect OFDM and CCK/DSSS packets. This requirement mandates the presence of dual receive paths that are active simultaneously and can decode an OFDM packet preamble and a CCK/DSSS packet preamble at the same time, without a priori knowledge. In particular, the sample rates of the different packets will be different. For example, the chip rate of an CCK/DSSS packet may be 11 Msps; whereas, the sample rate of an OFDM packet may be 20 Msps. Processing these received signals having different sample rates requires processors operating at the respective sample rate. In some instances, an increased sample rate can be used within a CCK/DSSS digital modem at the originating transmitter for pulse shaping. For example a CCK/DSSS modem may use four-times over sampling to meet the spectral mask requirements of CCK/DSSS (802.11b) resulting in a signal having a 4×11 Msps, or 44 Msps sample rate.

A typical implementation of an 802.11g compliant system is shown in FIG. 1. In general, an IEEE 802.11g wireless transmitter 100 includes an OFDM modulator 105 and a CCK/DSSS modulator 110. Each of the different modulators 105, 110 modulates data received at its input according to its respective modulation scheme. For complex signals, the output of each modulator 105, 110 generally includes both a respective in-phase (I) and a quadrature phase (Q) modulated digital signals. A pair of digital-to-analog (D/A) converters 120′, 120″ and 120′″, 120″″ (generally 120) receives the modulated digital signals from the I and Q outputs of a respective one of the modulators 105, 110. An RF front end 125 receives analog signals from each of the D/A converters 120 and up-converts the signal to the 2.4 GHz frequency band. The signal is ultimately transmitted through a transmit antenna 130.

Similarly, a wireless receiver 150 includes an RF front end 155 coupled to a receive antenna 140, for receiving a RF signal from an external source. The RF front end 155 down-converts the received RF signal to an analog baseband signal. For complex valued signals, the RF front end 155 outputs include separate I and Q analog baseband signals. Thus, a respective pair of analog-to-digital (A/D) converters 160′, 160″ and 160′″, 160″″ (generally 160) each receive the I and Q analog baseband signals and convert it to a corresponding digital signal. Each pair of A/D converters 160 samples the received analog signal at a different respective sampling rate—each different sampling rate corresponds to one of the two modulation schemes identified in the IEEE 802.11g standard. The IEEE 802.11g receiver 165 further includes an OFDM demodulator 170 and a CCK/DSSS demodulator 175, each demodulator 170, 175 respectively receiving digital signals from a respective one of the pair of A/D converters 160.

Notably, separate A/D and D/A converters are used for the OFDM and CCK/DSSS signal paths on each of the receive and transmit paths respectively. For receive, both paths are active simultaneously to detect and decode received data according to any of the IEEE 802.11g modulation schemes. This solution represents the simplest evolution of IEEE 802.11a and 802.11b systems towards 802.11g compliance. For the transmit path, one pair of D/A converters could be shared by each of the two modulators, but two clock sources would be required to clock the D/A converters at the appropriate rate based on the data rate of the modulator. Namely, the fundamental clock rate for an IEEE 802.11g OFDM signal is 20 MHz, whereas the clock rate for an IEEE 802.11g CCK signal is 22 MHz.

Unfortunately, using any of the prior art approaches for IEEE 802.11g compliance results in obvious disadvantages, such as increased cost and complexity. One solution requires four separate A/D and D/A converters (assuming an I/Q architecture), separate automatic gain control (AGC) loops for each receive path and a larger number of I/O ports in the digital baseband demodulator (if the OFDM and CCK/DSSS portions are on the same chip) or separate digital demodulators. Other solutions would require four separate A/D converters, and two separate D/A converters, with additional circuitry for different clocks and/or compensation circuits. Another consideration in adding complexity to any system is reliability—additional data converters and associated circuits of any kind reduces system reliability as the additional circuits are each prone to failure.

### SUMMARY OF THE INVENTION

The present invention solves the problems of prior art solutions for 802.11g WLAN systems by including a unified digital front end. The unified digital front end supports 802.11g communications at different symbol rates meeting the requirements of both the OFDM and the CCK/DSSS modulation schemes simultaneously, as required by the 802.11g specification. Moreover, the present invention reduces system cost and complexity by using half the number of A/D and D/A converters, I/O ports, and control loops required to interface them, as used by other prior art solutions.

In particular, the invention relates to a wireless receiver including an RF receiver coupled to A/D circuitry. The A/D circuitry is configured to provide a first digital signal at a first sampling rate. A receive digital rate-converter is coupled to the A/D circuitry and is configured to provide a second digital signal at a second sampling rate. A first demodulator is coupled to the A/D circuitry for demodulating the first digital signal, and a second demodulator is coupled to the receive digital rate-converter for demodulating the rate-converted, second digital signal. The rate converter allows an A/D converter to feed modulators of different rates. In one embodiment, the A/D circuitry is operated at a clock rate substantially equivalent to the first sampling rate. In operation, each of the first and second demodulators substantially simultaneously demodulates its respective received signal.

The first demodulator can be configured to demodulate an orthogonal frequency division multiplexed (OFDM) signal, such as an IEEE 802.11g OFDM signal. The second demodulator can be configured to demodulate a direct sequence spread spectrum (DSSS) signal, such as an IEEE 802.11b DSSS signal.

In some embodiments, the RF receiver receives a modulated wireless signal having a center frequency between about 2,400 MHz to about 2,484 MHz. The RF receiver can optionally be tuned to a predetermined channel frequency. A channel-selection filter can be coupled between the A/D circuitry and each of the digital rate-converter and the second demodulator for passing signals within the tuned channel and rejecting or attenuating signals outside of the tuned channel's bandwidth. For example, the channel-selection filter can be a finite impulse response (FIR) digital filter, such as an equi-ripple FIR digital filter.

In general, the digital rate converter includes a down sampler, an up sampler, and a filter coupled between the down sampler and the up sampler. The filter provides anti-aliasing and image rejection. The filter can be a FIR digital filter. In some embodiments, the digital rate-converter includes a polyphase filter bank.

The receiver can advantageously further include a control signal useful for selectively shutting down a portion of the receiver. For example, the control signal can be used for temporarily turning off one of the first demodulator and the combined receive digital rate-converter and second demodulator once a determination has been made as to which signal is being received (e.g., once one of the demodulators has successfully detected a packet preamble).

Alternatively, the invention relates to a transmitter having a first modulator providing a first modulated digital signal at a first sampling rate, and a second modulator providing a second modulated digital signal at a second sampling rate. The transmitter further includes a transmit digital rate-converter coupled to the second modulator. The transmit digital rate-converter is configured to provide a digital signal at the first sampling rate corresponding to the second modulated digital signal. Digital-to-analog circuitry is also provided and coupled to the transmit digital rate-converter and to the first modulator. The D/A circuitry is configured to provide an analog signal corresponding to one of the first modulated digital signal and the transmit digital signal at the first sampling rate. An RF transmitter front end is further coupled to the D/A circuitry for up converting the analog baseband signal to the selected RF channel frequency residing, for example, in the 2,400 to 2,484 MHz frequency band.

Generally, the transmitter can include a filter, such as a spectral mask filter, coupled between the D/A circuitry and each of the transmit rate converter and the first modulator. The transmitter can also be configured to further include a controllable transmitter switch for selectively coupling one of the transmit rate converter and the first modulator to the D/A circuitry. Further, as with the receiver, the transmitter can include a transmit control signal for selectively de-energizing the one of the first modulator and the combined transmit digital rate-converter and second modulator not required to support the particular packet being transmitted.

In some embodiments, the receiver is combined with a transmitter. Advantageously, in a transceiver embodiment including both a receiver and a transmitter, additional efficiencies can be obtained. For example, the receive digital rate converter and the transmit digital rate converter can be configured to use at least one common component, such as the rate converter, and/or the filter.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of one example of a prior art 802.11g system having independent front ends;

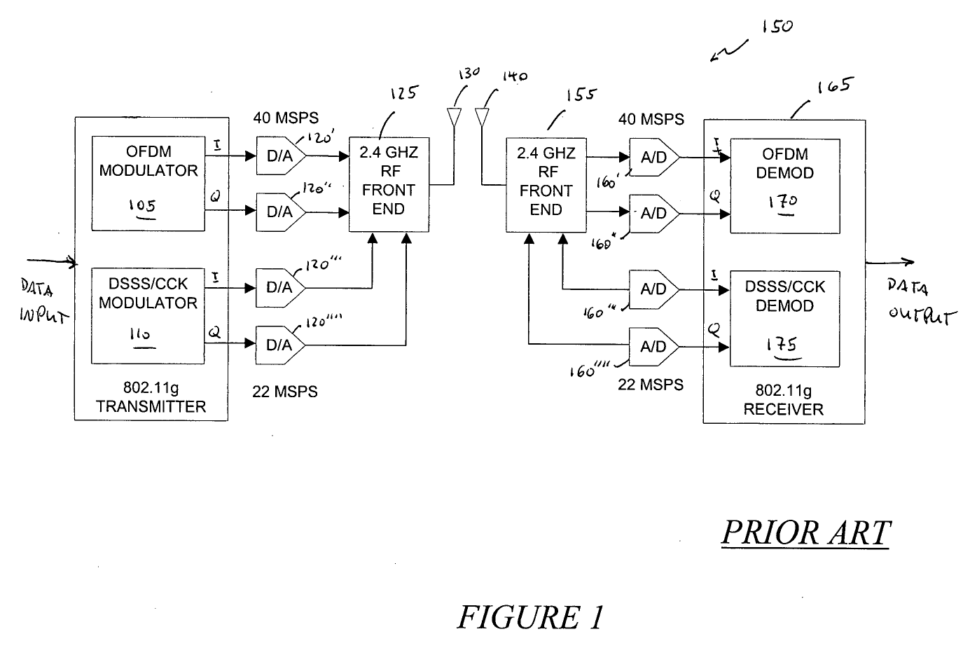

FIG. 2 is a block diagram of one embodiment of a wireless receiver including a unified 802.11g front end;

FIG. 3 is a block diagram of one embodiment of a wireless transmitter including a unified 802.11g front end;

FIG. 4 is graph illustrating exemplary baseband spectral mask requirements for OFDM modulation, defined by the IEEE 802.11a standard, and for CCK/DSSS modulation defined by the IEEE 802.11b standard; and

FIG. 5 is a block diagram of one embodiment of a wireless transceiver including a unified 802.11g front end having combined transmit and receive paths.

### DETAILED DESCRIPTION OF THE INVENTION

A description of preferred embodiments of the invention follows.

The present invention addresses the different sampling rate requirements of an 802.11g system in an efficient and cost-effective manner by using a unified digital front end. The unified digital front end includes multiple receive paths in combination with digital rate conversion filters. Improvements, for example, include an ability to use the same analog-digital converters for the different modulation schemes. As described above, the modulation scheme of the next packet received is not generally known for an IEEE 802.11g receiver. Namely, under the 802.11g standard, the packet could be either an OFDM packet or a CCK/DSSS packet. As the modulation scheme of the next packet is unknown, an appropriate receive path cannot be selected prior to packet reception.

Generally, in an IEEE 802.11g receiver embodiment, a received wireless signal is downconverted to a lower frequency (e.g., baseband), digitized and routed simultaneously through two separate receiver paths. More particularly, one of the receiver paths processes digitized received signals using OFDM modulation, while the other receiver path processes digitized received signal using CCK/DSSS modulation. Since an IEEE 802.11g signal will comply with one of the above-mentioned modulation schemes, one of the two active receive paths will correctly demodulate and identify the received packet. As described above, the different modulation schemes operate at different sampling rates, yet the received signal is advantageously digitized at one sampling rate to allow re-use of the A/D converters. The sampling rate of the A/D converters is selected to be the sampling rate of one of the two modulation schemes. A digital rate converter is applied to the other of the two receiver paths, converting the rate of one of the sampled signal to the sampling rate of the other. In general, the rate converter can be applied to either the OFDM or the CCK/DSSS receiver path, with the A/D sampling rate selected to be consistent with the sampling rate of the other receiver path.

A similar approach can also be applied to an IEEE 802.11g transmitter as well. That is, a unified digital front end can be used providing multiple transmit paths (i.e., two paths), each path corresponding to a different modulation scheme. In general, the unified digital front end receives transmit signals from different modulators having different sampling rates. The unified digital front end includes a rate converter applied to one of the transmit paths. Again, the rate converter adjusts the sampling rate of the signal received along its path to be the same sampling rate used on the other path. Beneficially, both transmit paths carrying transmit signals having a common sampling rate can use a common A/D converter clocked at the common sampling rate. Particular receiver and transmitter embodiments are discussed in more detail below.

Wireless Receiver

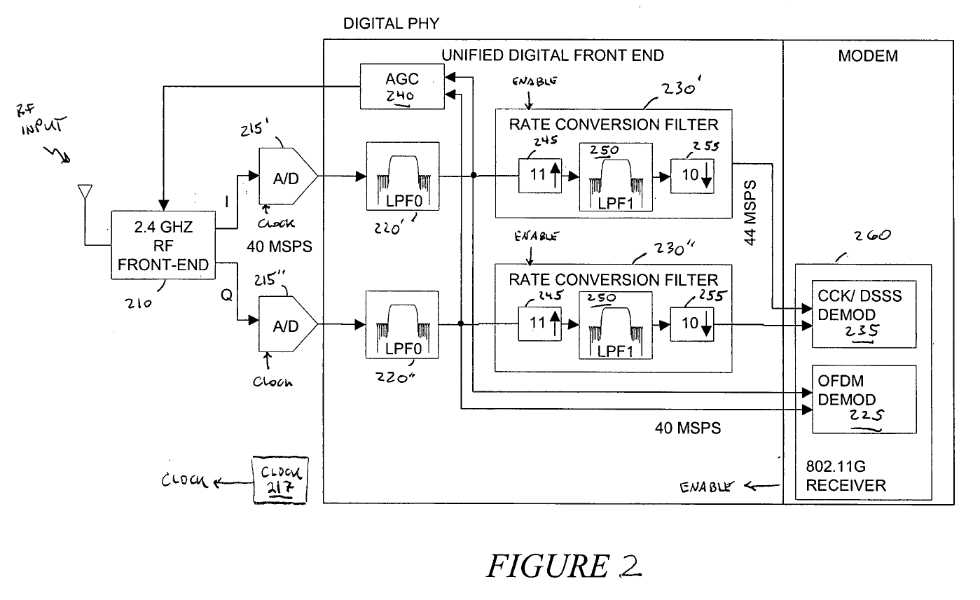

A multi-protocol receiver having separate received-signal paths configured to handle at least one of the multiple modulation schemes. For example, a block diagram of one embodiment of a wireless receiver 200 having dual signal paths configured to receive signals modulated with one of multiple modulation schemes according to 802.11g is illustrated in FIG. 2. A receive antenna 205 receives an RF signal from a remote source (not shown). The receive antenna 205 is coupled to an RF receiver front end 210 that down-converts the received RF signal to a lower frequency, such as an intermediate frequency (IF), or a baseband frequency. Although the term frequency is used as a singular term, the RF signal generally includes a range, or band of frequencies about some central frequency. Accordingly, the RF receiver front end 210 down-converts the bandwidth of the received signal, or channel, to a different frequency band, centered about a lower center frequency.

The RF receiver front end 210 is further coupled to A/D circuitry, such as an A/D converter, converting the down-converted analog signal to a corresponding digital signal for further processing by the receiver 200. As illustrated, the wireless receiver 200 is configured to receive a complex valued signal. Accordingly, the RF receiver front end 210 down-converts the received signal it into an in-phase (I) signal component, and a separate quadrature-phase (Q) signal component. Thus, each A/D converter 215′, 215″ (generally 215) is coupled to receive a respective one of the I and Q down-converted, analog received signals. Note that a single A/D converter 215 would be sufficient for an RF receiver front end 210 configured to down-convert a real-valued RF signal, as the RF front end 210 would provide a single output.

Each of the A/D converters 215 receives a timing, or clock input from a timing source. A single clock source 217 is used to provide a common clock signal to each of the A/D converters 215. Alternatively, a timing input signal can be obtained from an external source. Each of the A/D converters 215 uses its respective timing input to convert the received analog input signal into a corresponding digital output signal having a sampling rate related to the timing input. For example, the A/D converters 215 can sample an analog signal at a sample rate equivalent to a received clock input, such as the two-times oversampled OFDM rate of 40 MHz.

Each of the A/D converters 215 can be further coupled to a respective filter, such as a low-pass filter (LPF0) 220′, 220″ (generally 220). Each low-pass filter 220 is configured to pass signals having frequencies residing within a selected band of frequencies or channel defined as frequencies below some “cutoff” frequency. In this sense, the filter 220 can be referred to as a channel-selection filter 220. That is, each filter 220 effectively passes with minimal attenuation signals residing within a desired received channel, while rejecting by attenuation signals and interference at residing at frequencies outside of the desired channel.

Accordingly, the digitized output from each of the A/D converters 215 is passed through respective low pass filter 220, then to a first demodulator 225 configured to receive signals according to a first modulation type. For example, the first demodulator 225 can be an OFDM demodulator configured to receive and demodulate signals using OFDM modulation. Thus, for received signals using OFDM modulation, the OFDM demodulator 225 detects and demodulates the information, providing the output data to an external source. Should the received signal be a CCK/DSSS modulated signal, the OFDM demodulator 225 will not respond to it and, therefore, take no action.

The same digital output signal from each of the A/D converters 215 is passed through respective low pass filter 220, then to a second demodulator 235, through a respective receive digital rate converter 230′, 230″ (generally 230). Each of the rate converters 230 is configured to convert the digital output signal at a first sampling rate (e.g., 40 Msps) to a corresponding digital output signal at a second sampling rate (e.g., 44 Msps). In general, the rate converters 230 define a re-sampling ratio as the second sampling rate divided by the first sampling rate (e.g., a re-sampling ratio of 11/10, for the exemplary sampling rates described above). Each of the rate converters 230 are coupled to the second demodulator 235 configured to receive the rate-converted I and Q signals according to a second modulation type. For example, the second demodulator 235 can be a CCK/DSSS demodulator configured to receive and demodulate signals using CCK/DSSS modulation. Thus, for received signals using CCK/DSSS modulation, the CCK/DSSS demodulator 235 detects and demodulates the information, similarly providing its output data to the external source. Should the received signal be an OFDM modulated signal, the CCK/DSSS demodulator 235 will not respond to it and, therefore, take no action.

Receiver RF Front End

Describing, in turn, each of the major elements of the receiver 200 in more detail, the RF receiver front end uses the standard technique of mixing a received analog signal with a local oscillator signal to obtain a downconverted version of the received signal. Receivers that use a single mixing stage to convert the received RF signal to a corresponding analog baseband signal are well known in the art and commonly referred to as zero-IF receivers. In some embodiments, however, the RF receiver front end 210 includes multiple mixing stages, that mix the received RF signal with a first local oscillator yielding a version of the received signal at an intermediate frequency (IF), before further mixing the IF signal with one or more additional local oscillators ultimately yielding a down-converted version of the received signal. Receivers using multiple mixing stages are well known in the art and commonly referred to as super-heterodyne receivers.

Generally, the RF receiver front end 210 also includes at least some degree of signal conditioning. That is, signal gain is typically increased and/or attenuated using one or more cascaded amplifiers and/or attenuators. One common example is the inclusion of a low noise amplifier (LNA) in the RF receiver front end 210. An LNA is typically placed close to the antenna input to improve the performance of signal sensitivity and noise immunity. Other signal conditioning components commonly included in an RF receiver front end 210 include filters. For example, a band pass filter may be included between the antenna input and the first receiver amplifier to protect the receiver by attenuating any unwanted, out-of-band signals. Other filters, such as bandpass filters and/or surface acoustic wave filters can be used after any of the one or more mixing stages to further attenuate out-of-band signals. With either design, a received RF signal is ultimately converted to baseband whereupon the baseband signal is digitized and demodulated using DSP.

Receiver A/D Converters

Regarding the A/D converters 215, any of a number of commercially devices can be used, such as a dual (i.e., I and Q), 10 bit, 40 Msps A/D converter, part no. AD9218, available from Analog Devices, Inc., of Norwood, Mass. Selection of the A/D converters 215 is generally based on several criteria including the maximum bandwidth of the received analog signal and the desired dynamic range. Other factors for consideration include quantization error and linearity.

In some embodiments, the A/D converter 215 is selected to accommodate a bandwidth corresponding to one IEEE 802.11g channel (i.e., a bandwidth of approximately 16 MHz). Thus, according to the Nyquist criterion, the A/D sample rate must be double the highest frequency. In one particular embodiment, the A/D converters 215 sample the analog baseband input at 40 Msps. In another embodiment, the A/D converter 215 is selected to accommodate a bandwidth corresponding to the entire IEEE 802.11g receive band (i.e., a bandwidth of approximately 90 MHz). Accordingly, the A/D sample rate must be about 180 Msps.

In one particular embodiment, an A/D converter 215 is selected to provide 10 bits of resolution at a sampling rate of 180 Msps to sample the entire IEEE 802.11g frequency band. One example of such a high-speed A/D converter 215 is the 10 bit, 210 Msps A/D converter, part no. AD9410, available from Analog Devices, Inc., of Norwood, Mass. Using a wide-band A/D converter 215, the RF receiver front end 210 can down-convert the entire 90 MHz spectrum (i.e., 2,400 to 2,484 MHz) to baseband (i.e., 0 to 90 MHz). Thus, further re-tuning of the RF receiver front end 210 is unnecessary to operate on any of the multiple IEEE 802.11g channels identified within the band.

Notably, the 90 MHz frequency band accommodates up to three non-interfering channels: channel 1, centered at 2,412 MHz; channel 6, centered at 2,437 MHz; and channel 11, centered at 2,462 MHz. Thus, for D/A converters 215 that acquire the entire down-converted frequency band for further processing will be required to detect one of the channels. For example, the digitized wideband signal can be mixed with a digital carrier using available DSP techniques to selectably tune one of the channels to the passband of the low pass filter (LPF0) 220. Accordingly, the other channels are rejected by the filter 220, and the selected channel is processed as described above.

Receiver Low Pass Filter

In general, the low-pass filter 220 is designed to pass a desired portion of the baseband spectra, while attenuating frequencies above some maximum corner frequency. For example, the low-pass filter 220 can be designed to pass one IEEE 802.11g channel. A particular low-pass filter 220, such as an FIR, can be designed using any of a number of available filter design algorithms, tools, and techniques. First, however, certain performance criteria are selected prior to design, such as: pass-band frequency range, stop-band frequency range, in-band ripple, and the minimum rejection provided out-of-band, among other criteria. For embodiments, such as that illustrated in FIG. 2, the filter 220 should be a digital filter as it operates upon a digital signal. Thus, the filter 220 can be implemented in software, processing the values of the digital signal, or preferably in hardware, using DSP for higher-speed processing, with greater computational efficiency. Again, the filter 220 can be designed using one of the many available filter-design techniques for digital filters using the preselected design parameters. Exemplary filter-selection parameters that can be used to identify particular embodiments of the low-pass filter 220 are provided below in Table 1.

Receiver AGC Loop

Notably, in some embodiments, an automatic gain control (AGC) loop 240 is used to control gain applied within the RF receiver front end 210. For example, the AGC loop 240 can operating using the 40 Msps output sequence stream from each of the low-pass filters 220 as an input. The concept of using AGC within an RF receiver is well known and often used to effectively increase the dynamic range of the receiver 200. For example, AGC allows a receiver to receive strong signals from a nearby RF signal source without saturation and/or unnecessary distortion, while allowing the same receiver to also receive relatively weak signals from a more distant source, by providing signal amplification in the latter case. In a receiver processing digital signals, the AGC 240 can also be used to remove, or minimize a zero-frequency (i.e., DC) component that might otherwise limit the dynamic range performance of the A/D converters 215. In one embodiment, the AGC 240 includes an internal low pass filter filtering the digital signal received from the low pass filters (LPF0) 220. The AGC low-pass filtered signal is coupled from the AGC 240 to the RF receiver front end 210, which uses the received AGC signal to control the value of gain and/or attenuation applied during signal conditioning, as described above.

Receiver Digital Rate Converters

In one embodiment the rate converters 230 includes a re-sampler, such as an up sampler 245 receiving the output sequence at the first sampling rate from the low-pass filter 220. The up sampler 245 converts the received output sequence to an up sampled sequence at an interim sampling rate greater than the first sampling rate. Up sampling can include zero-stuffing, for example inserting zero-valued samples between the signal samples, thereby effectively increasing the signal sampling rate. The rate converters 230 can include a filter 250, such as a low pass filter, coupled to the up sampler 245 to essentially interpolate the zero-stuffed samples. The rate conversion process results in the generation of alias and image signal components occurring at multiples of the sample frequency, which are attenuated by the filter 250. In these instances, the filter 250 can be used to select a desired one of the aliased signals, such as the lowest frequency occurrence. The filter 250 can be realized as a finite impulse response filter (FIR). In some embodiments the filter is a FIR 250 designed according to the filter parameters listed in Table 1, under the heading “LPF1.” Further, if the interim up sample frequency is not the desired frequency, a down sampler 255 can be coupled to the filter 250 to further convert the up sampled sequence from the interim sampling rate to a corresponding digital signal at the desired, lower sampling rate.

Down sampling can be implemented by using a decimator. The decimator essentially picks every N^{th} sample and discards the samples in between resulting in an output digital signal at a lower rate. Down sampling might created alias versions of the original sampled signal that are spaced at multiples of the re-sampling rate. Accordingly, another filter can be coupled to the output of the rate converters 230 to pass a desired one of the aliased signals.

In some embodiments, the rate converters 230 each include a polyphase filter bank with a predetermined re-sampling ratio set, for example, at 11/10. Polyphase filtering is a well-known technique that simplifies the operation of the digital rate converters 230. For example, the upsampled signal is passed through the filter 250 having many more samples per second than either of the first and second sample rates (e.g., 440 Msps). Polyphase filtering techniques simplify the computational complexity of the filter, effectively reducing its processing requirements to that of a 44 Msps signal.

Demodulators

The first demodulator 225 demodulates the I and Q digital signals received from the two low-pass filters (LPF0) 220′, 220″. For example, the first demodulator 225 is configured to demodulate OFDM signals according to the IEEE 802.11g protocol. Thus, the OFDM demodulator 225 detects and demodulates the received digital signal. Typically, the demodulator 225, or the 802.11g receiver 260 interprets the demodulated signal, for example reading a preamble of a demodulated IEEE 802.11g OFDM packet. Accordingly, the OFDM demodulator 225, and/or the 802.11g receiver 260 can provide a control signal indicating that an OFDM packet has been received. As a power saving feature, this control signal can be used to selectively disable the rate converters 230 and/or the second demodulator 235 temporarily. For example, the rate converters 230 and/or second demodulator 235 can be disabled, or operated in a power-saving mode for the remainder of the one or more OFDM packets. After the one or more OFDM packets have been completely received, the control signal can likewise be used to re-enable the rate converters 230 and/or second demodulator 235.

Likewise, the second demodulator 235 demodulates the I and Q digital signals received from rate converters 230. For example, the second demodulator 235 is configured to demodulate an CCK/DSSS signal according to the IEEE 802.11g protocol. Thus, the CCK/DSSS demodulator 235 detects and demodulates the received digital signal. Typically, the second demodulator 235, and/or the 802.11g receiver 260 interpret the demodulated signal, by first reading a preamble of a demodulated IEEE 802.11g CCK/DSSS packet. Accordingly, the CCK/DSSS demodulator 235, and/or the 802.11g receiver 260 can provide a control signal, similar to that described above in relation to the OFDM demodulator 225, to indicate that a CCK/DSSS packet has been received. This control signal can similarly be used to selectively and temporarily disable the first demodulator 225, at least during periods of reception of the payload portion of CCK/DSSS packets.

Whichever power-saving scheme implemented, it is important that both of the separate receiver paths be operating during periods of signal acquisition, so that each receiver path may respectively demodulate and interpret packet preambles according to the multiple IEEE 802.11g modulation techniques.

Receiver Example

By way of example and in one embodiment, an RF front end 210 is tuned to a selected channel to receive a wireless signal, converting it to corresponding baseband I and Q analog signals. A/D converters 220 are configured to sample the I and Q analog baseband input at 40 Msps, representing a sampling rate equivalent to a two-times oversampled OFDM modulated signal having a sampling rate of 20 Msps. Low-pass digital filters 220 are used to filter each of the I and Q signals for channel extraction, operating on the 40 Msps output sequence to further suppress out of band noise. As described above, the 40 Msps output sequence is first passed directly to the OFDM demodulator 225, which demodulates an OFDM signal, if present. An AGC loop 240 runs on the 40 Msps stream. The same 40 Msps sequence is passed through the polyphase filter bank 230 with the re-sampling ratio set at 1/10. The rate converted 40 Msps×11÷10=44 Msps output sequence is next passed to the CCK/DSSS demodulator 235, which demodulates a CCK/DSSS signal, if present. Thus, the OFDM demodulator 225 and the CCK/DSSS demodulator 235 receive respective digital signals corresponding to the originally received wireless signal. To the extent the received signal is an 802.11g and/or 802.11b signal, an appropriate one of the demodulators 225, 235 will demodulate the signal.

Notably, the CCK/DSSS demodulator 235 receives a four-times over sampled digital stream (44 Msps sample rate compared to an 11 Msps chip rate) while the OFDM demodulator 225 receives a two-times over sampled stream (40 Msps sample rate compared to a 20 Msps sample rate). This over sampling can be exploited in the baseband timing recovery loop or in the channel estimation algorithms for improved receiver performance. Typical implementations use a two-times over sampled stream for timing recovery and equalization.

Having the appropriate demodulator 225, 235 interpret a packet preamble after demodulating the received signal, the 802.11g receiver 260 effectively knows which modulation type is being received. Accordingly, the demodulators 225, 235, and or the receiver 260 can provide a signal useful for disabling that receiver path not required for further reception of the packet. For example, if an OFDM packet preamble is received at the OFDM demodulator 225, the demodulator 225 can provide an enable signal to the CCK/DSSS demodulator 235 and to the rate converters 230. The enable signal can be used to temporarily disable, or shut down the CCK/DSSS path, or to operate it in a power-saving mode during the remainder of the packet. The enable signal may be used again to signal the completion of reception of a packet, thereby signaling to the CCK/DSSS demodulator 235 and the rate converters 230 to once again turn on and resume operation detecting subsequent packet headers. A similar enable signal can be provided by the CCK/DSSS demodulator 235 upon detection of a suitable packet to temporarily disable, or shut down and later turn on the OFDM demodulator 225.

Wireless Transmitter

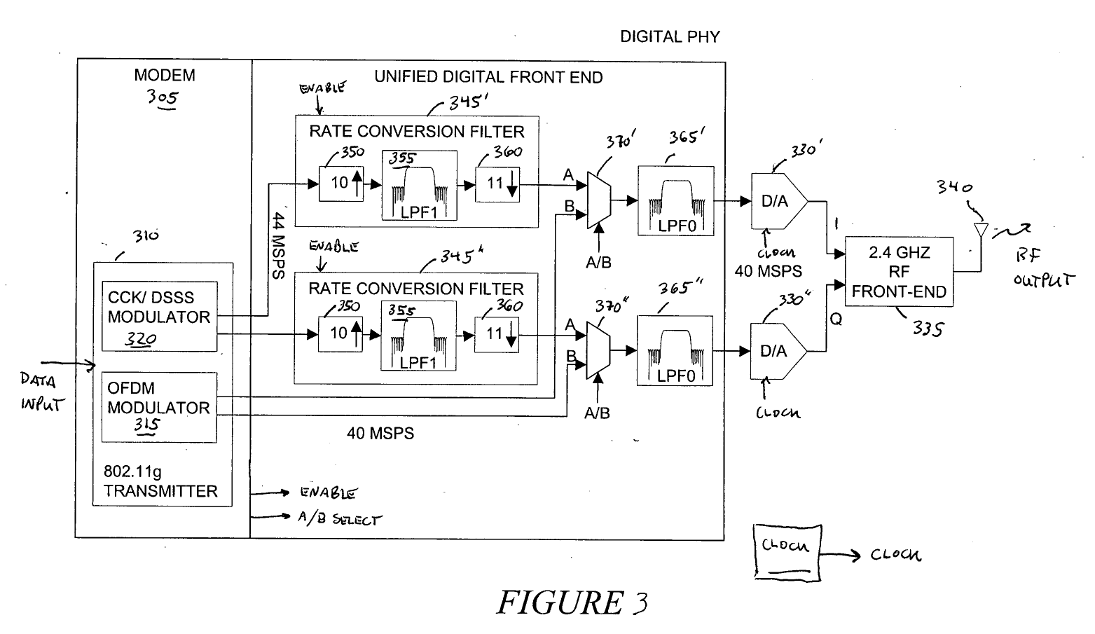

A multi-protocol transmitter includes separate transmit-signal paths, each path configured to handling at least one of multiple modulation schemes. For example, a block diagram of one embodiment of an IEEE 802.11g wireless transmitter 300 is illustrated in FIG. 3. Notably, transmitter 300 has dual signal paths and is configured to selectively transmit according to one of the multiple modulation schemes described in the IEEE 802.11g standard. By way of overview, the transmitter 300 includes a modem 305 receiving input data, such as a stream of binary digits or bits from an external source. The modem 305 includes an IEEE 802.11g transmitter 310 that modulates the received input data onto a digital carrier. The modulation is selectable according to one of the multiple modulation schemes of the 802.11g specification (i.e., CCK/DSSS or OFDM). In some embodiments, the 802.11g transmitter 310 includes two separate modulators: a first modulator 315 configured to modulate a digital carrier using OFDM modulation, and a second modulator 320 configured to modulate a digital carrier using CCK/DSSS modulation.

Each of the modulators 315, 320 is separately coupled to a unified digital front end 325. The unified digital front end 325 separately conditions each of the modulated digital carriers according to the type of modulation selected. The internal detail of the unified digital front end 325 is discussed in more detail below. The output of the unified digital front end 325 is further coupled to digital-to-analog (D/A) circuitry, such as D/A converters, converting the conditioned digital signal to a corresponding analog signal. In general, for complex-valued digital carriers, the A/D converters includes two D/A converters 330′, 330″ (generally 330), a respective converter 330 for each of the I and Q digital carriers. The output of the D/A converters 330 is further coupled to an RF transmitter front end 335. The RF transmitter front end 335 upconverts the analog signal to an RF signal, occupying a selected channel within a desired frequency band. The RF signal is ultimately coupled to a transmit antenna 340 for wireless broadcast to a remote destination.

In more detail, the unified digital front 325 end includes a digital rate converter 345′, 345″ (generally 345) converting the sampling rate of one of the received modulated digital signals to substantially the same sampling rate as the other one of the received modulated digital signals. For example, the unified digital front end 325 receives an OFDM modulated digital carrier at the two-times oversampled rate of 40 Msps. Alternatively, the unified digital front end 325 receives a CCK/DSSS modulated digital carrier at the four-times oversampled rate of 44 Msps. Thus, in one embodiment, the digital rate converter 345 operates upon the CCK/DSSS digital carrier, converting its sample rate from 44 Msps to 40 Msps. Consequently, the D/A converters 330 are clocked at the common sampling rate of 40 Msps so that they may selectively process either of the alternative modulated digital carriers. Alternatively the digital rate converter 345 operates upon the OFDM digital carrier, converting its sample rate from 40 Msps to 44 Msps. Consequently, the D/A converters 330 are clocked at the common sampling rate of 44 Msps so that they may selectively process either of the alternative modulated digital carriers

As described above in relation to the receiver 200, in one embodiment, each of the two transmit digital rate converters 345 includes an up-sampler 350 receiving the output sequence at the first sampling rate from the CCK/DSSS modulator 320. The up sampler 350 operates as described earlier, providing a rate-converted digital signal at an interim sampling rate greater than the first sampling rate. As with the receiver 200, the transmit digital rate converters 345 each include a respective filter 355 coupled to the up sampler 350 to isolate a desired one of the aliased versions of the original signal. Generally, the transmit digital rate converters 345 each include a respective a down-sampler 360 coupled to the filter 355 to convert the up sampled sequence from the interim sample rate to a desired sampling rate. For embodiments in which the ratio of the first to second sampling rates is a whole number, only one of the up sampler 350 and down sampler 360 is required. That is, the respective up/down sampling rate resulting in the second sampling rate when applied to the signal at the first sample rate. For the more general situation in which the ratio of the first to second sampling rates is not a whole number, but a ratio, the respective up and down sampling rates are selected to provide the desired ratio. A numerical example is provided below corresponding to the IEEE 802.11g protocol.

For an embodiment using the same polyphase filter bank as discussed above in relation to the receiver 200, the re-sampling ratio can be set at 11/10. Advantageously, the same low pass filter (LPF1) 365 using the same coefficients as used on receive. However, the polyphase arms of the transmit-mode rate converters 345 now have coefficients ordered differently from the polyphase arms of the receive-mode rate converters discussed above in relation to FIG. 2.

Notably, for the transmitter 300, the filtering sequence is reversed compared with that provided in the receiver 200. Thus, a pulse-shaping filter (LPF2) can be applied to the transmitted signal. Considering first the CCK/DSSS modulator 320, the pulse-shaping filter is not shown as it is generally be part of the modulator 320. For example, the pulse-shaping filter can be a raised-cosine filter or a Nyquist L^{th} band filter. Next, the pulse-shaped, 44 Msps stream is rate-converted using a transmit digital rate converter 345 configured as a polyphase rate conversion filter bank 345. In one embodiment, the re-sampling ratio for the transmit digital rate converter 345 is 10/11. Again, the low pass filter 355 can be an FIR filter coupled between the up-sampling and down-sampling stages. Although the sampling rate for this filter is 440 Msps, polyphase techniques can be used reduce the number of multiply-accumulate operations required to that of a 44 Msps filter. Thus, the output of the polyphase filter bank is a digital stream sampled at 40 Msps. This stream is passed through a final low pass filter stage (LPF0) 365′, 365″ (generally 365) to further attenuate signal components in the stop band.

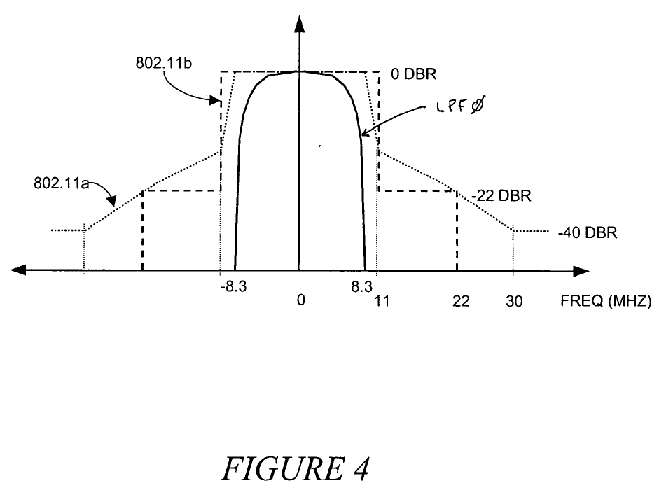

Considering next the OFDM modulator 315, pulse shaping is usually done using time domain windowing. The application of time-domain windowing within the OFDM modulator 315 is not shown as it is well know and considered to be part of the modulator 315. The native symbol rate stream at 20 Msps is up sampled by 2 to produce a 40 Msps stream at the output of the transmitter. The low pass filter (LPF0) 365 is used to meet the spectral mask requirements of the respective 802.11g modulation scheme as shown in FIG. 4. Thus, the transmit D/A converters 330 are clocked at 40 Msps, independent of which transmit modulation scheme is selected.

Transmitter Modem

Describing, in turn, each of the major elements of the transmitter 300 in more detail, the modem 305 includes a first modulator 315 modulating the input data stream into I and Q digital signals. The modulated I and Q signals are each coupled to a respective one of the two low-pass filters (LPF0) 365′, 365″. For example, the first modulator 315 is configured for OFDM modulation. Similarly, the modem 305 includes a second modulator 320 that also modulates the input data stream into I and Q digital signals. The modulated I and Q signals are each coupled to a respective one of the two transmit digital rate converters 345, before being further coupled to the low-pass filters (LPF0) 365′, 365″. For example, the second modulator 320 is configured for CCK/DSSS modulation.

As described above in relation to the receiver 200, the transmitter 300 can also be configured to include a power saving feature. Namely, only one of the first and second modulators 315, 320 are active during transmission of data. Thus, when one of the modulators is transmitting, the other can be disabled, shut down, or operated in a power-saving mode. When one of the modulator coupled to the transmit digital rate converters 345 is operated, the modulator 315, 320 and/or the transmitter 310 can provide a signal disabling the other modulator 315, 320 and/or rate converters for further power savings. In contrast to the receiver 200, determining which modulator/transmit path will be active in transmitting a particular data stream is straightforward, because the transmitter 300 necessarily knows before hand which modulator 315, 320 will be used to transmit a particular data packet. Selection of one of the modulation scheme of the multi-protocol transmitter can be made by a user, by a remote controller, or by any other suitable means for selecting one of the two available modulation schemes. For example, a performance parameter of the wireless communications, such as bit error rate and/or signal to noise ratio may be compared between each of the multiple modulation schemes and used in determining which type of modulation to select. Additional parameters, such as data rate can also be considered and used to manually and/or automatically make a selection. Thus, in contrast to the receiver 200, no more than one of the transmit paths need be active at any given time. Further, both paths can be disabled or shut down when no signals are being transmitted.

Transmit Digital Rate Converter

The transmit digital rate converters 345 operate similarly to the receiver rate converters 230 discussed above in relation to FIG. 2. That is, the transmit digital rate converter 345 receives a digital signal at a second sample rate, and converts it to a corresponding digital signal at a different, i.e., first, sample rate. In accomplishing the rate conversions, similar approaches can be used including an up sampler 350 for upsampling, a filter 355 for filtering, and a down sampler 360 for downsampling. Again, the rate converter 345 can include a polyphase filter for accomplishing the rate conversion. For example, the same rate converter 345 can be used for both receive and transmit, with the direction of up/down sampling reversed along with a reversal of the ordering of the coefficients of the filter taps. Thus, a 44 Msps signal can be received from the CCK/DSSS modem 320, upsampled by a factor of 10, to a 440 Msps, filtered and downsampled by a factor of 11 resulting in an output digital signal having a sampling rate of 44×10÷11=40 Msps. In some embodiments, the transmit digital rate converter filter LPF1 355 uses the same coefficients as used on receive. However, the polyphase arms now have coefficients ordered differently.

Transmitter Selection Switch

In some embodiments, a controllable transmitter switch is used to selectively couple digital signals from one of the two modulators 315, 320 to the low pass filter 365. For I and Q signals, two switches can be used, as illustrated, one switch for each of the I and Q signals. For example, the switches can be multiplexers 370′, 370″ (generally 370). The multiplexers 370 receive a signal (e.g., an “A/B” select signal) from the transmitter 310, and/or the modulators 315, 320 indicating which of the two paths is currently transmitting. The multiplexer 370 then couples the selected one of the A or B designated paths to the low pass filter 365.

Transmitter Low Pass Filter

The transmitter low pass filter (LPF0) 365 passes the desired signal frequency components (e.g., one IEEE 802.11g channel), and can therefore be the same filter as described above in relation to the receiver 200 of FIG. 2.

Transmitter D/A Converters

Any of a number of commercially available D/A converters can be used, such as the 10 bit D/A converter, part no. AD973 1, available from Analog Devices, Inc., of Norwood, Mass., designed for communications systems and providing wideband spurious-free dynamic range. Selection of the D/A converters 330 is generally based on several criteria including the maximum bandwidth of the received analog signal and the desired dynamic range. Other factors for consideration include quantization error and linearity. Another high-speed D/A converter 330 is a custom device described in co-pending U.S. patent application Ser. No. 10/653,710, incorporated herein by reference in its entirety.

In one particular embodiment, the D/A converters 330 convert the digital signals using sampling rate of 40 Msps.

Transmitter Example

By way of example and in one embodiment, a selected one of the OFDM modulator 225 and the CCK/DSSS modulator 235 transmits a respective digital signal corresponding to data received from an external source (e.g., a computer). The respective modulator 225, 235 receiving the input data modulates a digital signal accordingly. As described above, a 40 Msps output sequence is routed from the OFDM modulator 315 through a multiplexer and the low pass filter 365 to the D/A converter 330. The 44 Msps, four-times oversampled sequence is alternatively routed from the CCK/DSSS modulator 320 through the polyphase filter bank 345 generating a rate-converted 40 Msps output sequence. The rate-converted output is next passed through the multiplexer 370, through the low pass filter 365, and to the D/A converter 330. Depending upon which modulator 315, 230 is operational, the respective modulator 315, 320 or the 802.11g transmitter 310 provides an “A/B” control signal to the multiplexer 370, selectively coupling one of the transmit signal paths to the D/A converters 330.

Table 1 provides exemplary suggested specifications for the filters used in some embodiments of the unified digital front end.

TABLE 1
Digital filter specifications
LPF0

| Type | Equi-ripple, Finite Impulse Response (FIR) | |
|---|---|---|
| Sampling Rate | 40 | Msps |
| Pass band | 0-8.3 | MHz |
| Stop band | 13.7-20 | MHz |
| Taps | 32 | |

LPF1

| Type | Equi-ripple, FIR (polyphase filter bank) | |
|---|---|---|
| Sampling Rate | 440 | Msps |
| Pass band | 0-8.3 | MHz |
| Stop band | 31.7-220 | MHz |
| Taps | 40 | |

LPF2 (DSSS Transmit Only)

| Type | 4^{th} order Nyquist FIR | |
|---|---|---|
| Sampling Rate | 44 | Msps |
| Roll off | 0.5 | |
| Taps | 24 | |

Transceiver

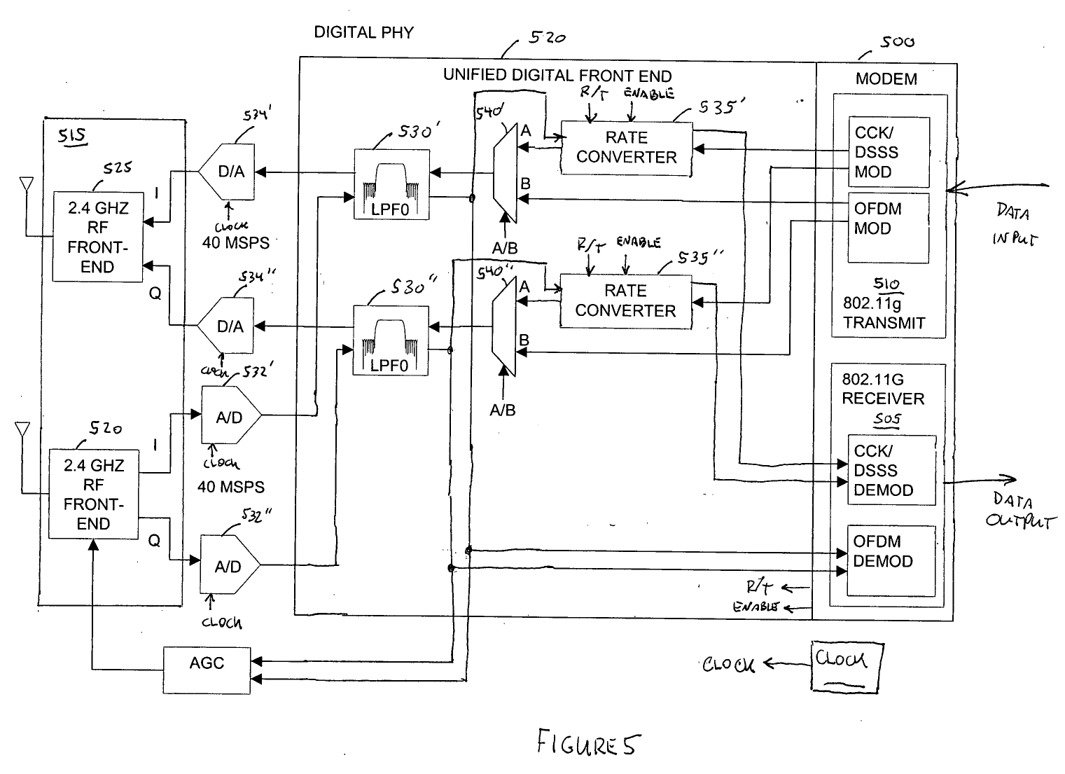

In an alternative embodiment, a receiver and a transmitter can be combined forming a transceiver. A transceiver is a more typical application for an 802.11g system, for example representing a “wireless access point,” as the system generally transmits and receives with remote wireless sources. For example referring now to FIG. 5, a modem 500 includes both an 802.11g receiver 505 and an 802.11g transmitter 510, each similar to its respective device already described with respect to FIGS. 2 and 3. Additional hardware efficiencies can be realized by combining the receiver 520 and transmitter 525. For example, a common local oscillator, and/or a common mixer(s) can be shared.

The modem 500 is coupled to the RF transceiver front end 515 through a common unified digital front end 520. The RF transceiver front end 515 generally includes an RF receiver 520 and transmitter 525 each similar to its respective device already referred to with respect to in FIGS. 2 and 3. The internal configuration of the unified digital front end 520 includes a pair of low pass filters 530 coupling OFDM signals between the modem 500 and A/D converters 532′, 532″ (generally 532), and the modem 500 and D/A converters 534′, 534″ (generally 534). The converters 532, 534 are further coupled to the RF transceiver front end 515. Thus, the same filters 530 can be reused for both transmit and receive operation.

Digital rate converters 535′, 535″ (generally 535) are coupled between the modem 500 and the low pass filters 530 for converting the sampling rate of one of the signals, such as one of the OFDM or CCK/DSSS modulated signals. In a transmit mode of operation, transmit selection multiplexers 540′, 540″ (generally 540) selectively connect the output of either the rate converters 535 or the OFDM modulated signals to the low pass filters 530. In receive mode of operation, the low pass filters 530 remain coupled to the modem 500 for carrying OFDM received signals, and to the rate converters 535 for carrying CCK/DSSS received signals. Thus, the digital rate converters 535 can also be reused for both transmit and receive operation. As described above in relation to the digital rate converters of FIG. 3, the same polyphase rate conversion filters can be used for receive and transmit operation, with some reconfiguration depending on the particular mode. Namely, the direction (i.e., up/down) of the respective samplers alternates direction, and the ordering of the filter coefficients flips direction between either transmit or receive mode. Accordingly, the rate converters 535 generally receive a receive/transmit (R/T) signal indicative of the transmit/receive mode of operation. Thus, the rate converters 535 set the direction of the samplers and the ordering of the filter coefficients in response to the received R/T signal. Such a reordering can be accomplished using software instructions for a software implementation of the rate converters 535. Alternatively, the reordering can be accomplished using digital signal processors responsive to the RIT signal in a hardware/DSP implementation. The R/T signal can be provided by the modem 500, the receiver 505, and/or the transmitter 510.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless receiver comprising:
a radio-frequency (RF) receiver front end;
analog-to-digital (A/D) circuitry coupled to the RF receiver front end, the A/D circuitry configured to provide a digital signal at a first sampling rate;
a receive digital rate-converter coupled to the A/D circuitry, the receive digital rate-converter configured to provide a digital signal at a second sampling rate;
a first demodulator coupled to the A/D circuitry, the first demodulator demodulating the digital signal received from the A/D circuitry at the first sampling rate;
a second demodulator coupled to the digital rate converter, the second demodulator demodulating the digital signal from the receive rate converter at the second sampling rate.

2. The wireless receiver of claim 1, wherein the A/D circuitry is operated at a clock rate substantially equivalent to the first sampling rate.

3. The wireless receiver of claim 1, wherein each of the first and second demodulators respectively demodulates substantially simultaneously the first digital signal at the first sampling rate and the second digital signal at the second sampling rate.

4. The wireless receiver of claim 1, wherein the RF receiver front end receives modulated wireless signal having a center frequency between about 2,400 megahertz to about 2,484 megahertz.

5. The wireless receiver of claim 4, wherein the RF receiver front end is tunable to a predetermined channel frequency.

6. The wireless receiver of claim 1, further comprising a channel-selection filter coupled between the A/D circuitry and each of the receive digital rate-converter and the first demodulator.

7. The wireless receiver of claim 6, wherein the channel-selection filter comprises a finite impulse response (FIR) digital filter.

8. The wireless receiver of claim 1, wherein the digital rate-converter comprises:
a down sampler;
an up sampler; and
a filter coupled between the down sampler and the up sampler.

9. The wireless receiver of claim 8, wherein the filter comprises an anti-aliasing filter.

10. The wireless receiver of claim 9, wherein the anti-aliasing filter is a finite impulse response (FIR) digital filter.

11. The wireless receiver of claim 1, wherein the receive digital rate-converter comprises a polyphase filter bank.

12. The wireless receiver of claim 1, wherein the first demodulator is an IEEE 802.11g demodulator, demodulating an orthogonal frequency division multiplexed (OFDM) signal.

13. The wireless receiver of claim 1, wherein the second demodulator is an IEEE 802.11g demodulator, demodulating a direct sequence spread spectrum (DSSS) signal.

14. The wireless receiver of claim 1, further comprising a control signal for selectively shutting down one of the first demodulator and the combined receive digital rate-converter and second demodulator.

15. A wireless transmitter comprising:
a first modulator providing a first modulated digital signal at a first sampling rate;
a second modulator providing a second modulated digital signal at a second sampling rate;
a transmit digital rate-converter coupled to the second modulator, the transmit digital rate-converter configured to provide a rate-converted digital signal at the first sampling rate corresponding to the second modulated digital signal;
digital-to-analog (D/A) circuitry selectively coupled to one of the transmit digital rate-converter and the first modulator, the D/A circuitry configured to provide an analog signal corresponding to one of the first modulated digital signal and the rate-converted digital signal; and
a radio frequency (RF) transmitter front end coupled to the D/A circuitry, up converting to RF the analog signal received from the D/A circuitry.

16. The wireless transmitter of claim 15, wherein the transmit digital rate-converter comprises:
an up sampler;
a down sampler; and
a filter coupled between the up sampler and the down sampler.

17. The wireless transmitter of claim 16, wherein the filter comprises an anti-aliasing filter.

18. The wireless transmitter of claim 17, wherein the anti-aliasing filter is a finite impulse response (FIR) digital filter.

19. The wireless transmitter of claim 15, wherein the transmit digital rate-converter comprises a polyphase filter bank.

20. The wireless transmitter of claim 15, wherein the first modulator is an IEEE 802.11g modulator, modulating an orthogonal frequency division multiplexed (OFDM) signal.

21. The wireless transmitter of claim 15, wherein the second modulator is an IEEE 802.11g modulator, modulating a direct sequence spread spectrum (DSSS) signal.

22. The wireless transmitter of claim 15, further comprising a filter coupled between the D/A circuitry and each of the transmit rate converter and the first modulator.

23. The wireless transmitter of claim 22, further comprising a controllable transmitter switch selectively coupling one of the transmit rate converter and the first modulator to the D/A circuitry.

24. A wireless transceiver comprising:
a radio-frequency (RF) front end converting a signal between RF and analog baseband;
data conversion circuitry coupled to the RF front end, the data conversion circuitry configured to convert between an analog baseband signal and a corresponding digital signal at a first sampling rate;
a digital rate-converter coupled to the data conversion circuitry, converting the digital signal at a first sampling rate to a digital signal at a second sampling rate; and
a modem having:
a modulator selectably coupled to one of the data conversion circuitry and data conversion circuitry through the digital rate-converter; and
a demodulator simultaneously coupled to the data conversion circuitry and the data conversion circuitry through the digital rate-converter.

25. The transceiver of claim 24, further comprising a filter coupled between the data conversion circuitry and the modem.

26. The transceiver of claim 24, wherein the modem uses IEEE 802.11g modulation techniques.

27. The transceiver of claim 24, further comprising an automatic gain control (AGC) loop coupled between the demodulator and the RF front end, the AGC loop processing the digital signal at the first sampling rate.

28. A method for receiving a wireless signal comprising:
receiving a radio-frequency (RF) signal;
converting the received signal to a first digital signal at a first sampling rate;
rate-converting the first digital signal at the first sampling rate to a second digital signal at a second sampling rate;
demodulating the first digital signal; and
demodulating the second digital signal.

29. The method of claim 28, wherein the A/D circuitry is operated at a clock rate substantially equivalent to the first sampling rate.

30. The method of claim 28, wherein the first digital signal and the second digital signal are demodulated substantially simultaneously.

31. The method of claim 28, wherein the RF receiver front end receives modulated wireless signals having center frequencies from about 2,400 megahertz to about 2,484 megahertz.

32. The method of claim 31, further comprising tuning the RF receiver front end to a predetermined channel frequency.

33. The method of claim 28, further comprising filtering a selected channel using a channel-selection filter.

34. The method of claim 28, wherein rate-converting uses polyphase filtering techniques.

35. The method of claim 28, wherein rate-converting further comprises:
down sampling to a third, lower sampling rate the second digital signal;
filtering the down-sampled signal to substantially remove aliased signal components; and
up sampling to the first sampling rate the down-sampled, filtered signal.

36. The method of claim 28, wherein demodulating comprises demodulating an orthogonal frequency division multiplexed (OFDM) signal.

37. The method of claim 28, wherein demodulating comprises demodulating a direct sequence spread spectrum (DSSS) signal.

38. The method of claim 28, further comprising selectively shutting down circuitry associated with one of the first demodulator and the combined receive digital rate-converter and second demodulator.

39. A method for transmitting a wireless signal comprising:
modulating a first digital signal at a first sampling rate;
modulating a second digital signal at a second sampling rate;
rate-converting the first digital signal to a rate-converted digital signal at the second sampling rate;
digital-to-analog (D/A) converting the rate-converted digital signal to a corresponding analog transmit signal; and
transmitting a wireless radio-frequency signal (RF) corresponding to the analog transmit signal.

40. The method of claim 39, wherein the D/A circuitry is operated at a clock rate substantially equivalent to the first sampling rate.

41. The method of claim 39, wherein a radio frequency (RF) transmitter front end up converts the analog transmit signal to a wireless signals having a center frequency between about 2,400 megahertz to about 2,484 megahertz.

42. The method of claim 41, further comprising tuning the RF transmitter front end to a predetermined channel frequency.

43. The method of claim 39, further comprising filtering the digital signal.

44. The method of claim 39, wherein rate-converting uses polyphase filtering techniques.

45. The method of claim 39, wherein rate-converting further comprises:
up sampling the second digital signal to a higher sampling rate;
filtering the up-sampled signal; and
down sampling the filtered, up-sampled signal to the first sampling rate.

46. The method of claim 39, wherein modulating comprises modulating an orthogonal frequency division multiplexed (OFDM) signal.

47. The method of claim 39, wherein modulating comprises modulating a direct sequence spread spectrum (DSSS) signal.

48. The method of claim 39, further comprising selectively coupling one of the first modulator and the transmit digital rate-converter to the D/A circuitry.

49. A wireless receiver comprising:
means for receiving a radio-frequency (RF) signal;
means for converting the received signal to a digital signal at a first sampling rate;
means for rate-converting the digital signal at the first sampling rate to a digital signal at a second sampling rate;
means for demodulating the digital signal at the first sampling rate; and
means for demodulating the digital signal at the second sampling rate.

50. A wireless transmitter comprising:
means for modulating the digital signal at the first sampling rate;
means for modulating the digital signal at the second sampling rate;
means for rate-converting the digital signal at the first sampling rate to a digital signal at a second sampling rate;
means for digital-to-analog (D/A) converting the rate-converted digital signal to a corresponding analog signal; and
means for transmitting a wireless radio-frequency signal (RF) corresponding to the converted analog signal.
